(19) United States
(12) Patent Application Publication
(10) Pub. No.: US 2026/0120525 A1
(43) Pub. Date: Apr. 30, 2026

(54) MATERIALS HANDLING VEHICLE NOTIFICATION SYSTEM

(71) Applicant: Crown Equipment Corporation, New Bremen, OH (US)

(72) Inventors: Claire Spicer, Anna, OH (US); Trisha Luthman, Covington, OH (US); Paul Magee, Tipp City, OH (US); Justin Montan, Troy, OH (US); Aaron Williams, Lima, OH (US); Joshua Robinson, Anna, OH (US); Jess Gilland, Saint Marys, OH (US); Tom Luan, Troy, OH (US); Milan Pema, Springboro, OH (US)

(21) Appl. No.: 19/369,999

(22) Filed: Oct. 27, 2025

Related U.S. Application Data
(60) Provisional application No. 63/712,184, filed on Oct. 25, 2024.

(51) Int. Cl. G07C 5/00; B66F 9/075; G06F 3/04842; G07C 5/08

(52) U.S. Cl. CPC G07C 5/008; B66F 9/0755; G07C 5/0825; G06F 3/04842; G06F 2203/04803

(57) ABSTRACT

A notification system for use in a materials handling vehicle includes a display and a processor. The display has a screen that displays a graphical user interface (GUI). The GUI includes a first panel displaying live vehicle data associated with a first vehicle function, wherein the first panel can be controlled to toggle between a prioritized state and a non-prioritized state, and a second panel displaying live vehicle data associated with a second vehicle function, wherein the second panel can be controlled to toggle between a prioritized state and a non-prioritized state. The processor is communicably coupled to the display to control the GUI. The processor is programmed to detect an event associated with the first panel or the second panel and to apply the prioritized state or the non-prioritized state to the first panel or the second panel based on the detecting of the associated event.

### CROSS REFERENCE TO RELATED APPLICATION

This application claims the benefit of U.S. Provisional Patent Application Ser. No. 63/712,184, filed Oct. 25, 2024, entitled MATERIALS HANDLING VEHICLE NOTIFICATION SYSTEM, by Spicer et al. and having attorney docket CRN 1115 MA, the disclosure of which is hereby incorporated herein by reference.

### FIELD

Various aspects of the present disclosure relate generally to a notification system for a materials handling vehicle, and more particularly to a notification system that can dynamically respond to operational vehicle conditions and/or operational vehicle data to provide an indication of pertinent information that can be visually discerned.

### BACKGROUND

Materials handling vehicles are commonly used for picking stock in warehouses and distribution centers. Such materials handling vehicles typically include a power unit and a load handling assembly, which may include load carrying forks. Materials handling vehicles also include control structures, e.g., within an operator's compartment, so that a vehicle operator can control operation and movement of the corresponding materials handling vehicle.

### BRIEF SUMMARY

According to aspects of the present disclosure, a notification system for use in a materials handling vehicle includes a display and a processor. The display has a screen that displays a graphical user interface (GUI). The GUI includes a first panel displaying live vehicle data associated with a first vehicle function, wherein the first panel can be controlled to toggle between a prioritized state and a non-prioritized state, and a second panel displaying live vehicle data associated with a second vehicle function, wherein the second panel can be controlled to toggle between a prioritized state and a non-prioritized state. The processor is communicably coupled to the display to control the GUI. The processor is programmed to detect an event associated with the first panel or the second panel and apply the prioritized state or the non-prioritized state to the first panel or the second panel based on the detecting of the associated event.

According to further aspects herein, a process comprises associating a first panel with a first event, wherein the first panel includes an indication of live materials handling vehicle data associated with a first vehicle function and can be controlled to toggle between a prioritized state and a non-prioritized state. The process also comprises associating a second panel with a second event, wherein the second panel includes an indication of live materials handling vehicle data associated with a second vehicle function. The process moreover can be controlled to toggle the panels between a prioritized state and a non-prioritized state. For instance, the process comprises sending the first panel for display in a graphical user interface (GUI) and sending the second panel for display in the GUI. The process also comprises receiving an indication that the first event or the second event has occurred and applying the prioritized state or the non-prioritized state to the first panel or the second panel based on the detecting of the associated event.

According to still further aspects herein, a process for controlling a notification system of a materials handling vehicle is provided. The process comprises associating a first panel with a first event, wherein the first panel includes an indication of live materials handling vehicle data associated with a first vehicle function, and associating a second panel with a second event, wherein the second panel includes an indication of live materials handling vehicle data associated with a second vehicle function. The process further comprises receiving an indication of an issue with the materials handling vehicle, wherein the issue is associated with the first vehicle function. Moreover, a type of issue is determined, and a treatment is determined based on the type of issue. A message associated with the issue is displayed using the treatment, and a portion of the first panel is modified to include the treatment.

### BRIEF DESCRIPTION OF THE SEVERAL VIEWS OF THE DRAWINGS

FIG. 1 is a schematic view of an operating environment for materials handling vehicles;

FIG. 2 is a side view of a materials handling vehicle having a technology feature that implements a remote-controlled travel function;

FIG. 3 is a schematic diagram of several electrical components of a materials handling vehicle that support one or more technology features;

FIG. 4 is a schematic diagram illustrating a display mounted on a materials handling vehicle;

FIG. 5A illustrates an example notification system according to aspects herein;

FIG. 5B illustrates an example notification system according to aspects herein;

FIG. 5C illustrates an example notification system according to aspects herein;

FIG. 5D illustrates an example notification system according to aspects herein;

FIGS. 6A-D illustrate panels of the example notification system, according to aspects disclosed herein;

FIG. 7 illustrates an example process for carrying out a notification system according to aspects herein; and

FIGS. 8A-C illustrate activating additional applications from the example notification system, according to aspects of the present disclosure.

In the following detailed description of the illustrated embodiments, reference is made to the accompanying drawings that form a part hereof, and in which is shown by way of illustration, and not by way of limitation, specific embodiments in which the disclosure may be practiced. It is to be understood that other embodiments may be utilized and that changes may be made without departing from the spirit and scope of various embodiments of the present disclosure.

### DETAILED DESCRIPTION

Aspects herein provide an operator-facing user experience centered around a notification system that utilizes one or more glanceable panels including information elements. Each panel provides a prioritized view that provides information that an operator may deem relevant to a task at hand. For instance, in a single view (layout) a panel space (dashboard) of a display may present a load prioritized view (via a load panel, which includes elements for weight, height, etc.) and a vehicle prioritized view (via a vehicle panel, which includes a speed element, a direction element, etc.). Additional panels may optionally also be provided and selected by a user, such as a power (e.g., battery) panel.

### System Overview

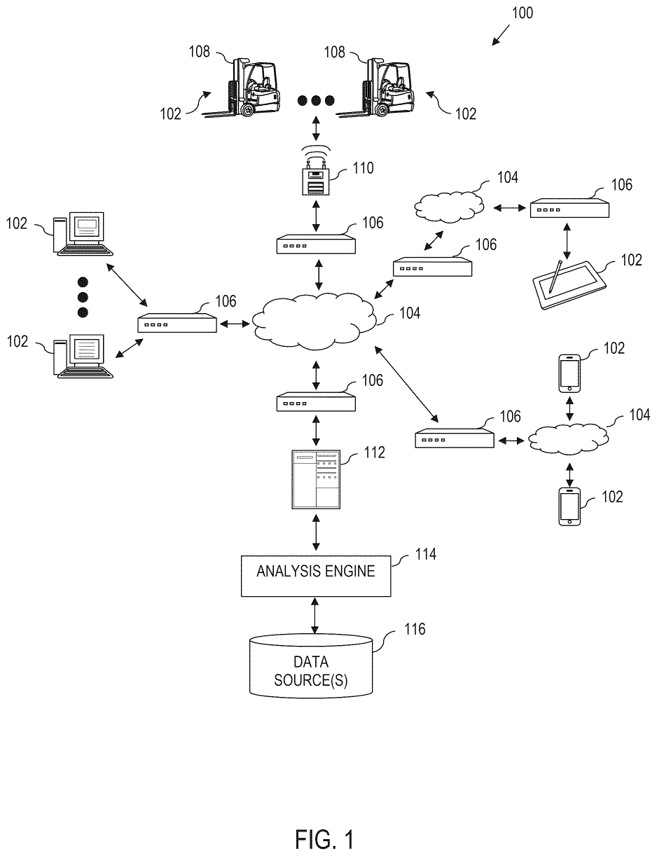

Turning now to the figures and in particular to FIG. 1, a schematic diagram of an industrial computer system 100 is illustrated, according to various aspects of the present disclosure.

The industrial computer system 100 comprises a plurality of hardware processing devices 102 that can communicate with each other. As a few illustrative examples, a processing device 102 can be implemented as a smartphone, laptop, tablet, personal computer, server computer, special purpose device, etc. For instance, in certain contexts and roles, a select processing device 102 is intended to be mobile, such as a hardware-based processing device provided on a materials handling vehicle 108 (e.g., a forklift truck, reach truck, stock picker, turret truck, tow tractor, rider pallet truck, walkie stacker truck, pallet jack, etc.).

For instance, certain processing devices 102 may be able to directly or indirectly communicate with each other, e.g., via a wireless communication technology, examples of which include Wi-Fi, Bluetooth, ultra-wideband, Zigbee, Infrared Data Association (IrDA), Near Field Communication (NCF), cellular, other, etc.

In this regard, processing devices 102 may be able to communicate across one or more network(s) 104. Here, the network(s) 104 may be supported by networking components 106 that facilitate communication between processing devices 102. Example networking components 106 include for example, routers, hubs, firewalls, network interfaces, wired or wireless communications links and corresponding interconnections, cellular stations, and corresponding bridges/conversion technologies.

To facilitate wireless communication between processing devices 102, the industrial computer system 100 can include nodes 110 (e.g., one or more Wi-Fi access points, wireless routers, Bluetooth tags, ultra-wideband anchors, reflectors, QR/bar codes, Radio Frequency Identification (RFID) pills, Infrared Data Association (IrDA) receivers/ transmitters, radio frequency (RF), cellular routers, NFC nodes, combinations thereof, etc.). Here, each node 110 can couple to a corresponding network 104, optionally, through one or more additional networking component(s) 106.

The illustrative computer system 100 also includes a hardware server 112 (e.g., a web server, file server, and/or other processing device) that supports an analysis engine 114 and corresponding data source(s) 116. In an example implementation, the analysis engine 114 can support collecting, processing, outputting, etc., data collected by or otherwise utilized by materials handling vehicles 108 operating within the industrial computer system 100.

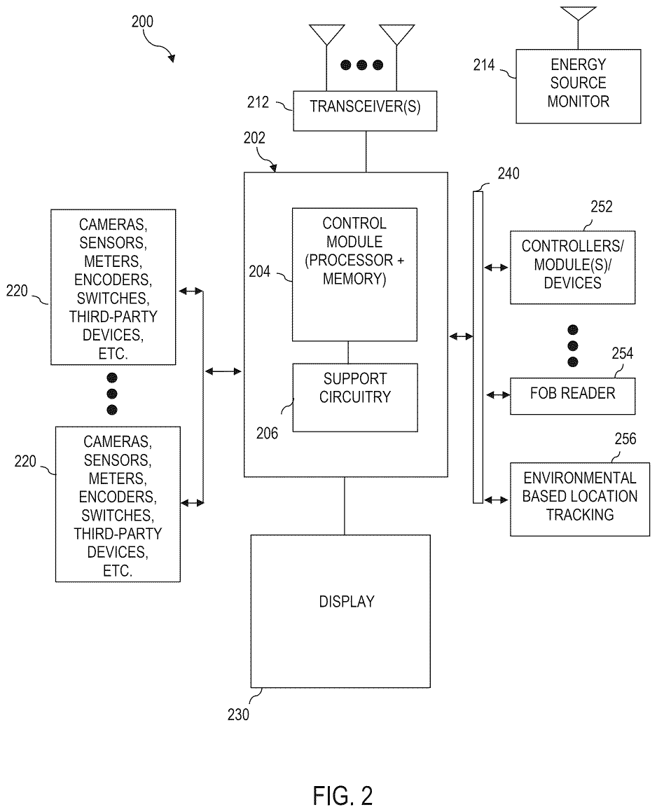

Industrial Vehicle Electronics Referring to FIG. 2, a schematic diagram 200 illustrates an exemplary electrical system for a materials handling vehicle. The schematic diagram 200 is not intended to be exhaustive. Rather, the schematic diagram is intended to highlight certain features helpful in understanding aspects disclosed herein.

In particular, a processing device 202 is provided on a materials handling vehicle (e.g., a processing device 102 on a materials handling vehicle 108, FIG. 1). Here, the processing device 202 is a special purpose, particular hardware computer, such as a device that mounts to or is otherwise integrated with the materials handling vehicle.

The illustrated processing device 202 can include a control module 204, support circuitry 206, and other optional circuitry. Moreover, the processing device 202 can be communicably coupled to vehicle circuitry, such as one or more transceivers 212, an energy source monitor 214, peripheral device(s) 220, a display(s) 230, interface(s) 240, or combinations thereof.

The control module 204 can include, for instance, one or more processors, memory, controllers, buffers, convertors, other circuitry etc., for carrying out functions of the processing device 202, as described more fully herein. By way of brief introduction, the memory can be used to store vehicle events, configuration data, logged vehicle data, control data, set points, a software client, security code, processing instructions, etc. The processor(s) can be used to collect data, perform computations, perform real-time data processing, implement vehicle functionality, implement a display engine, perform I/O processing, communicate with native vehicle controllers, etc. In this regard the processor(s) and memory of the control module 204 can be used to carry out computer implemented processes, alone or in combination with other processing devices (on or off the associated materials handling vehicle) as described more fully herein.

The support circuitry 206 provides the circuitry necessary to enable the control module 204 to interact with other features of the materials handling vehicle. By way of non-limiting example, the support circuitry 206 can implement interfaces, such as a universal serial bus (USB) interface, network interface(s), a pogo pin interface etc. The support circuitry 206 can also provide video ports, camera ports, input/output ports (e.g., to interface with a keypad, touchscreen, lights, audible features, haptic features, etc.), additional examples of which are described more fully herein.

The processing device 202 (e.g., via the control module 204) can communicate via one or more transceivers 212, e.g., via Wi-Fi, Bluetooth, ultra-wideband, Zigbee, IrDA, Near Field Communication (NCF), cellular, radio frequency (RF), combinations thereof, etc. Moreover, each transceiver technology can include one or more antenna, e.g., for redundancy, for location/position determination, for reliability, combinations thereof, etc.

The materials handling vehicle can also include an energy source monitor 214. For instance, the corresponding materials handling vehicle may include a battery as a source of energy. Here, the energy source monitor 214 may be coupled to the battery to measure and log battery characteristics, such as current discharges, temperature, resistance, etc., for measuring and/or computing remaining battery charge, battery state of health, battery state of charge, etc. Here, the energy source monitor 214 can include a wireless transceiver that pairs with the transceiver 212 so that the processing device 202 and the energy source monitor 214 can share information. As an alternative, the energy source monitor 214 can communicably couple to the processing device 202 via a wired connection.

The processing device 202 can optionally communicate with various materials handling vehicle peripheral devices 220 (e.g., cameras, lasers, sensors, meters, encoders, light bars, sound/haptic devices, Internet of Things (IOT) devices, scanners, switches, controls, third party devices, vehicle control and/or enabling circuitry (e.g., key switching), microphones, headsets, etc.), e.g., for data logging, hour meter logging, automated control, data monitoring, facilitating communication with electronics external to the processing device 202, etc.

The processing device 202 can also interface with a display 230, e.g., to provide glanceable information, to carry out inspection checklists, to facilitate operator login, etc., examples of which are described more fully herein.

In some implementations, the processing device 202 can communicate across one or more native vehicle interfaces 240, e.g., a Controller Area Network (CAN) bus, universal serial bus (USB) interface, I/O interface, Local Interconnect Network (LIN), time-triggered data-bus protocol (TTP) bus, RS422 bus, ethernet bus, etc.

The interface(s) 240 facilitate the processing device 202 communicating with native materials handling vehicles features, such as controllers 252 (e.g., hydraulic controller, traction controller, steer controller, or other devices that conventionally communicate across native vehicle interface(s).

The processing device 202 can also communicate, e.g., via an interface 240, with a fob reader 254 (or keypad, card reader or any other device) for receiving operator credentials.

According to yet further aspects of the present disclosure, the processing device 202 can communicate, e.g., via an interface 240, with a location tracking device 256 that is provided on the materials handling vehicle. The location tracking device 256 enables the materials handling vehicle to be spatially aware of its location within a local space, e.g., within a warehouse.

Thus, the processing device 202 connects with, understands and is capable of communication with materials handling vehicle components, such as peripheral devices, transceivers, displays, controllers, readers, environmental location tracking devices, etc.

### Display Component

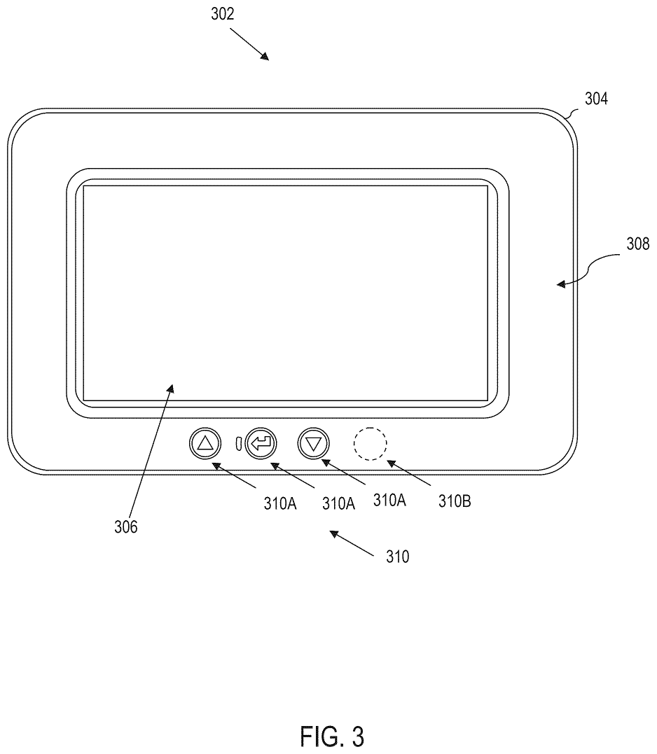

Referring briefly to FIG. 3, an example display 302 (e.g., analogous to the display 230) is illustrated. The display 302 is any device that can present data that can be visually discerned. By way of nonlimiting example, the display can utilize technology to present data using a liquid crystal display (LCD) screen, Light Emitting Diode (LED) screen; Organic Light Emitting Diode (OLED) screen; a thin-film transistor (TFT) screen; a segment display screen; a graphic display screen; etc.

The display 302 includes a housing 304 having a display section 306. For instance, in the illustrated example, the display 302 can also optionally include a bezel 308 (e.g., a frame). Moreover, the bezel 308 may support a vehicle operator control section 310. The vehicle operator control section 310 can include hardware controls 310A, e.g., one or more navigation buttons, an enter/select button, a power button, one or more encoders (e.g., see optional rotary encoder 310B), etc., in any combination.

In some implementations, the display may include or otherwise support, optional user interface features, such as a touch screen, inductive screen, proximity sensor, gesture control functionality, etc. In this regard, program code can enable graphic elements to functionally respond to touch, proximity, gesture controls, etc. In some implementations, program code can be utilized to graphically display a separate/distinct user interface section, e.g., to implement graphically displayed navigation controls, e.g., to augment, duplicate, replace, etc., hardware controls.

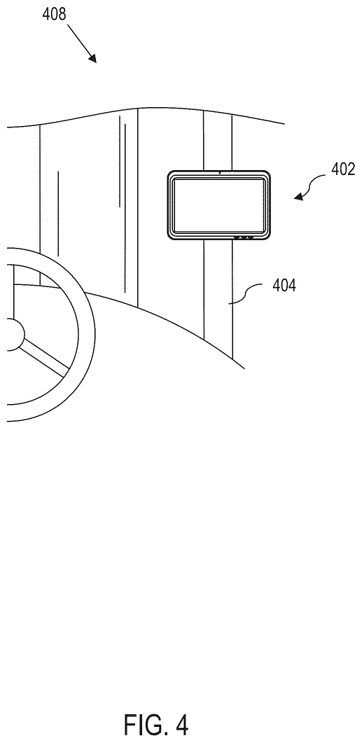

Referring to FIG. 4, a display 402 is illustrated in the context of being mounted to a materials handling vehicle. In this regard, the display 402 can be implemented as the display 302, FIG. 3, or display 240, FIG. 2.

As illustrated, the display 402 is mounted to a support bar 404 of a materials handling vehicle 408. Here, the materials handling vehicle 408 is analogous to the materials handling vehicle 108, FIG. 1. In practice, the display 402 can be mounted in, on, to, integrated with, or otherwise provided for various types of materials handling vehicles 408, including but not limited to a forklift truck, reach truck, stock picker, turret truck, tow tractor, rider pallet truck, walkie stacker truck, etc.

In this regard, the size, shape, and other physical characteristics of the display 402 can vary depending upon the application. For instance, if the display 402 is mounted inside an operator's compartment of the materials handling vehicle 408, the front face can conform to neighboring structures, e.g., instrument/control cluster, etc. If the display 402 is mounted to the materials handling vehicle 408, e.g., to the support bar 404 (or other structure such as a mount, a harness, other supporting structure, etc., the display 402 may include other features, e.g., a ball mount, swivel mount, etc., so that the display 402 can be adjusted, e.g., by an operator.

### Materials Handling Vehicle Notification System Overview

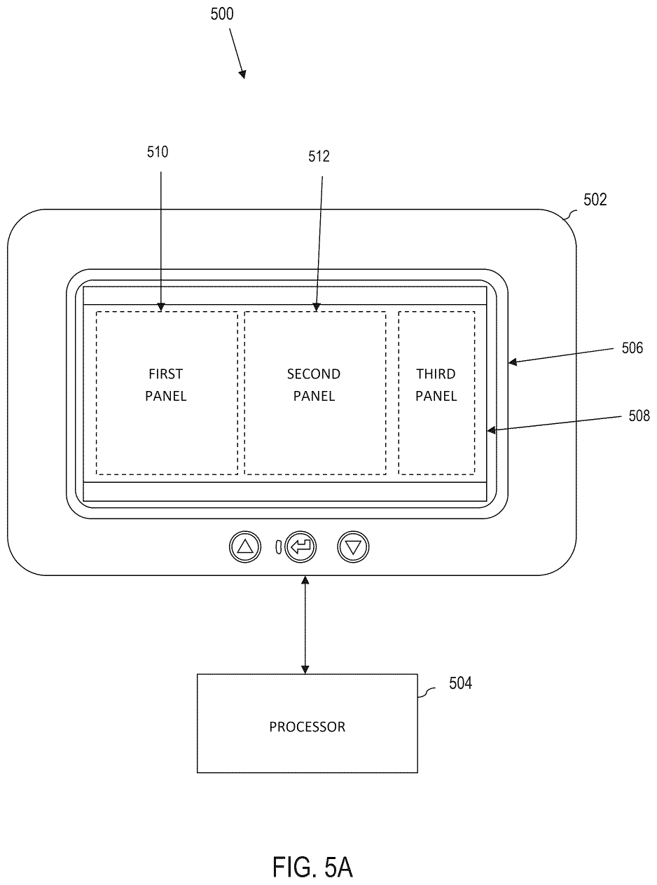

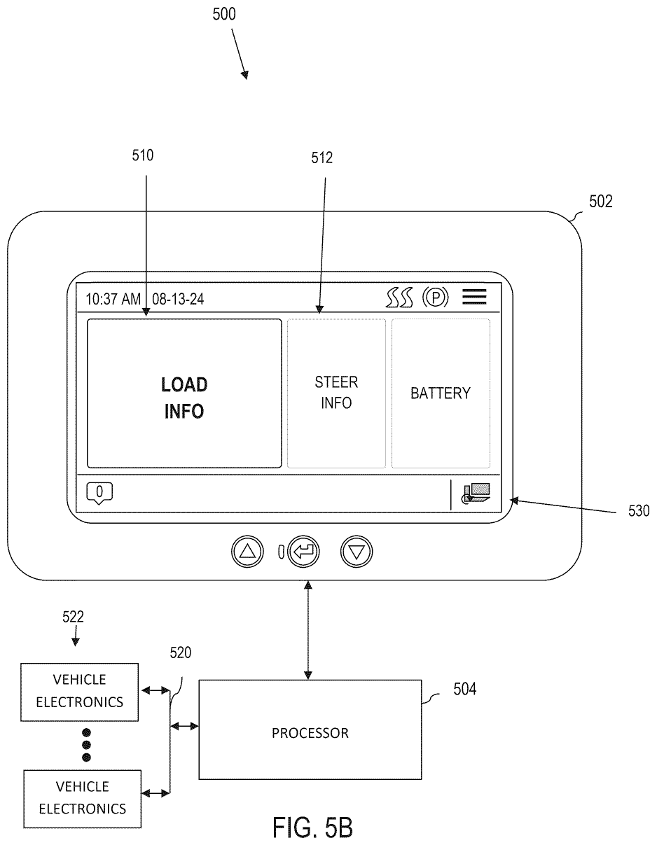

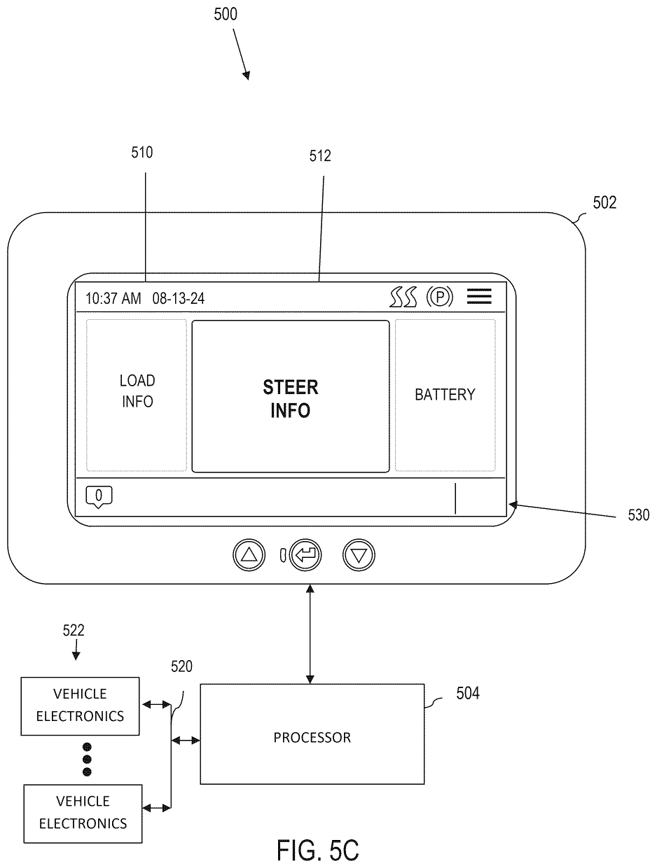

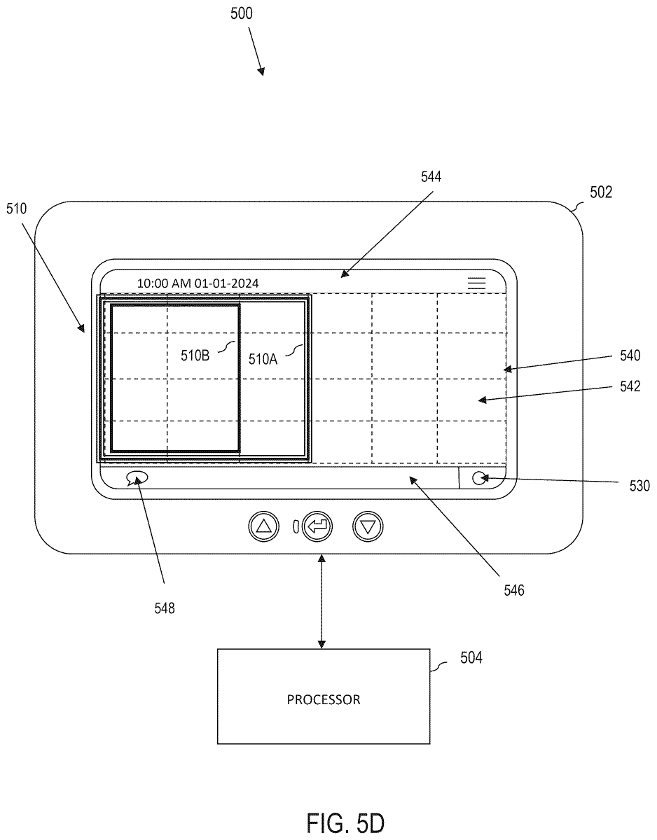

Referring to FIG. 5A, a notification system 500 is illustrated. In general, the notification system 500 includes a display 502 and a processor 504.

The display 502 can be implemented as the display 402, FIG. 4, the display 302, FIG. 3, display 230, FIG. 2, etc.

The processor 502 can implement the processing device 202, FIG. 2, any one or more of the processing device(s) 102, FIG. 1, etc. For instance, in some implementations, the processor 504 can be integrated into the display 502. In other implementations, the processor 504 is mounted on a corresponding materials handling vehicle, that is communicably coupled to the display 502. In yet other implementations, the processor 504 may comprise processing that is not co-located, e.g., some processing carried out by a processor on the materials handling vehicle, and some processing carried out by a remote processing device, e.g., a server that processes materials handling vehicle data (e.g., see processing devices 102 on materials handling vehicles 108 communicating with server 112, FIG. 1).

The processor 504 controls the display 502 to present one or more “panels”. As used herein, a “panel” displays information related to a specific function, feature, designation, or other aspect related to the corresponding materials handling vehicle, the vehicle operator, the environment associated with the materials handling vehicle, etc. Each panel may be fixed in size. As another example, select panels may be able to be re-sized, e.g., to bring attention to, to reduce attention to, or otherwise affect an operator's view of the panel. Elements (or aspects) displayed in the panels, the entire panel itself, or both can vary in color, text, or other visual attributes, based upon the desired functionality.

As a few illustrative but non-exhaustive examples, a panel can be utilized to graphically depict materials handling vehicle load information (e.g., fork height, load on forks, fork tilt angle, combinations thereof, etc.), movement information (e.g., travel direction, speed, steer information such as steer angle, combinations thereof, etc.), or energy source information (e.g., battery charge information).

In an example implementation, the display 502 can divide the viewable screen into a load prioritized view, a materials handling vehicle prioritized view, and optionally, an energy source view. By way of example, the load prioritized view can graphically depict one or more panels directed to load, load control, load handling capability, load handling position or orientation, etc. As a further example, the materials handling vehicle prioritized view can graphically depict one or more panels directed to the materials handling vehicle, such as travel direction (e.g., traveling in a forks first direction or operator compartment first direction), speed, steer angle, etc.

The display 502 can also present other features, such as a status tray, menu system, information bar, messaging bar, menu system, login screen, checklist application, etc., examples of which will be described in greater detail herein.

### Notification System—Example 1

According to aspects herein, an example notification system 500 is provided, for use in a materials handling vehicle. The notification system 500 comprises the display 502 and the processor 504, where the processor 504 is communicably coupled to the display 502.

Communicably coupled means that the processor can exchange information with the display. This can occur through wired or wireless communication. Moreover, communication need not be continuous. Rather, the processor 504 needs only to communicate with the display 502 when an exchange of information occurs. Thus, continuous, physical coupling is not required.

The display 502 has a screen 506 that displays a graphical user interface (GUI) 508.

The GUI 508 graphically depicts a first panel 510 displaying live vehicle data associated with a first vehicle function. Here, the first panel 510 can be controlled (e.g., by the processor 504) to toggle between a prioritized state and a non-prioritized state. For sake of illustration, the first panel 510 visually depicts load information. For example, with brief reference back to FIG. 2, the processing device 202 can communicate across the interface 240 (e.g., a CAN bus) to extract the current state information from one or more controllers 252 (e.g., a hydraulics controller, a load handling controller, etc.). The processing device 202 can then interact with the display 230—shown as display 502, FIG. 5. With reference back to FIG. 5, the first panel 510 can use graphical icons (e.g., information elements such as a tilt element, a weight element, a steering angle element, etc.), text, color, size, sound, etc., to provide the load information extracted by the processor 502.

The GUI 508 also graphically depicts a second panel 512 displaying live vehicle data associated with a second vehicle function. Here, the second panel can be controlled (e.g., by the processor 504) to toggle between a prioritized state and a non-prioritized state. For sake of illustration, the second panel 512 visually depicts steer information. Analogous to that above, for example, with brief reference back to FIG. 2, the processing device 202 can communicate across the interface 240 (e.g., a CAN bus) to extract the current state information from one or more controllers 252 (e.g., a traction controller, a steer controller, etc.). The processing device 202 can then interact with the display 230-shown as display 502, FIG. 5. With reference back to FIG. 5, the second panel 512 can use graphical icons (e.g., information elements such as a tilt element, a weight element, a steering angle element, etc.), text, color, size, sound, etc., to provide the steer information extracted by the processor 502.

As used herein, a “prioritized state” is a view of a panel that includes an attribute that causes a change in the visual appearance of the panel where the change is something other than the content of the underlying data being presented in the panel. For instance, a prioritized state can be defined by increasing the size of a panel in at least one dimension relative to a non-prioritized state; providing a visually differentiating feature such as an outline, box, shadow, etc., that is not visually discernable in a non-prioritized state; changing a thickness or a color of the outline (or box or shadowing) of the panel compared to the non-prioritized state; changing a background color of the panel compared to the non-prioritized state; providing a dynamic element such as a grow feature, flashing, blinking, or other dynamic feature that is not provided in a non-prioritized state; changing the color of at least one element of the panel compared to the non-prioritized state; adding more elements to the panel; other visually discernable difference between the prioritized state and non-prioritized state; combination thereof, etc.

Here, the processor 504 is programmed (e.g., via memory of the control module 204 of the processing device 202, FIG. 2) to detect an event associated with the first panel 510 or the second panel 512. Responsive to detecting the event, the processor 504 is further programmed to apply the prioritized state or the non-prioritized state to the first panel 510 or the second panel 512.

Referring generally to FIG. 5B and FIG. 5C, the first panel 510 shows load information, and the second panel 512 shows vehicle information including a steer element. The processor 504 is illustrated coupled to one or more interfaces 520 to materials handling vehicle electronics 522. For example, with reference to FIG. 2, the processor of the control module 204 within the processing device 202 can communicate with vehicle electronics (e.g., peripherals 22, controllers 252, etc., via an interface 240, such as a CAN bus, RS422 bus, ethernet bus, USB bus, combination thereof, etc. This allows the processor 504 to extract “live” data from the materials handling vehicle, e.g., live state data regarding the state of load information and steer information, to populate the elements of the first panel 510 and the second panel 512 with live data.

Prioritized State vs. Non-prioritized State

As noted above, the first panel 510 can be controlled to toggle between a prioritized state and a non-prioritized state. With specific reference to FIG. 5B compared to FIG. 5C, the first panel 510 is illustrated in a “prioritized state” in FIG. 5B and a non-prioritized state in FIG. 5C. The “prioritized state” designation can be distinguished in FIG. 5B over FIG. 5C based upon the color of at least one element of the first panel 510, the bolding of the information of at least one element of the first panel 510, the border around the first panel 510, the size of the first panel 510 (larger in FIG. 5B compared to FIG. 5C), or a combination of these features.

Likewise, as noted above, the second panel 512 can be controlled to toggle between a prioritized state and a non-prioritized state. With specific reference to FIG. 5B compared to FIG. 5C, the second panel 512 is illustrated in a non-prioritized state in FIG. 5B and a prioritized state in FIG. 5C. The “prioritized state” designation can be distinguished in FIG. 5C over FIG. 5B based upon the color of at least one element of the second panel 512, the bolding of the information of at least one element of the second panel 512, the border around the second panel 512, the size of the second panel 512 (larger in FIG. 5C compared to FIG. 5B), or a combination of these features.

Here, the processor 504 is programmed to detect an event associated with the first panel 510 or the second panel 512 (which may include detecting events associated with both the first panel 510 and the second panel 512). The processor 504 applies the prioritized state or the non-prioritized state to the first panel 510 or the second panel 512 (which may include applying the prioritized state or the non-prioritized state to both the first panel 510 and the second panel 512) based on the detecting of the associated event.

For example, if the materials handling vehicle is stopped, but is raising its forks, the processor 504 may cause the GUI to transition the first panel 510 to the prioritized state and the second panel to the non-prioritized state as illustrated in FIG. 5B.

Next, if the forks are lowered, and the traction control is engaged to start driving the materials handling vehicle forward, the processor may set the first panel 510 to the non-prioritized state and transition the second panel to the prioritized state, as illustrated in FIG. 5C.

As a few other examples, if the materials handling vehicle is performing an operation such as blending (raising the forks while traveling), both the first panel 510 and the second panel 512 may optionally be brought to the prioritized state.

Likewise, if the materials handling vehicle is stationary with no load, the first panel 510 and the second panel 512 may both be presented in the non-prioritized state.

In an example implementation, the notification system 500 is configured such that the processor 504 is further programmed to ensure that only one of the first panel 510 and the second panel 512 is in the prioritized state at any given time, e.g., as demonstrated between FIG. 5B and FIG. 5C.

In another example implementation, the notification system 500 is configured such that the processor 500 is programmed to detect an event by being programmed to monitor an interface (e.g., the CAN bus) of the materials handling vehicle, for data associated with the event as described more fully herein with reference to FIG. 2 and/or FIG. 5B, FIG. 5C. For instance, in FIG. 2, the processor of the processing device 202 can monitor peripherals 220, controllers 252, etc., via an interface, such as a vehicle network bus or other interface as described more fully herein. Likewise, as illustrated in FIG. 5B, FIG. 5C, the processor 504 is illustrated communicating across an interface 520 with vehicle electronics 522.

In yet another example implementation, the notification system 500 can be configured such that the processor 504 is programmed to detect an event by being programmed to detect a user selection of the first panel 510 or second panel 512. Solely by way of example, and not by way of limitation, with reference to FIG. 5B and FIG. 5C, the GUI displays within a designated space, e.g., in a task bar, a view select control 530. For instance, in FIG. 5B, the view select control 530 shows an icon of a load on forks, designating that the first panel 510 is in a prioritized state in this example. An operator can touch the priority select control to scroll, toggle, navigate, etc., to change priority. For instance, with reference to FIG. 5C, after the operator accessing the view select control 530, the priority state has transitioned from the first panel 510 (FIG. 5B) to the second panel (FIG. 5C). Moreover, in FIG. 5C, an icon within the view select control 530 has changed to a steering wheel to graphically designate that the second panel 512 is in the priority state (in this example-however, other icons may be used to indicate the view). Manual selection of a prioritized state can also/alternatively be achieved by the operator tapping on the panel that the operator wants to bring into the prioritized state. In many embodiments, the view select control 530, selection via a panel, or both are disabled when the vehicle is moving.

In yet another example implementation, the notification system 500 can be configured such that the processor 504 is programmed to detect an event by determining a current task of the materials handling vehicle. As a few illustrative examples, the processor 504 can identify that a task is being performed in a number of ways. For example, the operator can utilize an input device to identify to the processor 504, a task to be performed. As another example, the processor 504 can detect the current task by acquiring information from vehicle electronics 522. As yet another example, with brief reference back to FIG. 1, the processor (e.g., processor of the processing device 102; FIG. 1) can communicate across the network to the server 112, e.g., to obtain information from a warehouse management system (WMS) that designates a task to be performed by the materials handling vehicle.

In some implementations, the notification system 500 is configured such that the first panel 510 includes more displayed information when in the prioritized state (FIG. 5B) than when in the non-prioritized state (FIG. 5C).

In some implementations, the notification system 500 is configured such that the first panel 510 is displayed using a first color (e.g., black outline in FIG. 5B) for at least one element when in the prioritized state and a second color (e.g., gray in FIG. 5C) different from the first color for the element when in the non-prioritized state (FIG. 5C).

In some implementations, the notification system 500 is configured such that the first panel 510 is larger when in the prioritized state (FIG. 5B) than when in the non-prioritized state (FIG. 5C).

### Panel Layout

Referring to FIG. 5D, in example implementations, the notification system 500 can be configured such that the GUI of the display includes a dashboard 540. Here, the first panel and the second panel are in the dashboard (see first panel 510 and second panel 512; FIG. 5A). Other layouts may also be included but are not discussed with detail herein. For example, there may be a login layout where an operator logs into the vehicle; there may be a messaging layout, where larger alert messages are displayed; there may be a customization layout, where a user selects which panels will be displayed in the panel layout and select some customization options; there may be other layouts as well.

Moreover, the notification system 500 can be configured such that the dashboard 540 is divided into tiles 542 as a smallest unit of resolution for a panel. Any number of tiles 542 can be provided. For instance, FIG. 5D illustrates tiles 542 arranged in an m×n array where m and n are each any whole number greater than zero. For instance, a 6×4 array of tiles 542 is visible on the display screen of the display 502, for sake of illustration. Each tile 542 can be the same size or a different size. Moreover, each tile 542 will in practice comprise any number of pixels of the display.

The utilization of tiles 542 as units of size for panels provides a convenient way to consistently define tiles that are fixed size or tiles that grow/shrink based upon various conditions (e.g., change to/from prioritized state), the addition of additional/fewer panels, the need for messaging, etc. Moreover, this allows panels to be resized, e.g., to grow to bring a particular prioritized view more prominently into the dashboard (e.g., to accommodate situations with high or low quantities of information, to highlight more important information, etc.).

Solely for sake of example, FIG. 5D illustrates a first panel 510 in two states, a prioritized state 510A and a non-prioritized state 510B. In some example implementations, the first panel 510 includes more tiles 542 when in the prioritized state 510A than when in the non-prioritized state 510B. For instance, as illustrated, the first panel 510 utilizes 12 tiles 542 in the prioritized state 510A, whereas the first panel 510 utilizes 8 tiles 542 in the non-prioritized state.

In some embodiments, the GUI of the display 502 can further include a status tray 544 (also known as a header tray) that is separate from the dashboard 540. The status tray can provide the time, date, show the status of certain vehicle features (e.g., Wi-Fi strength, key on status, battery charge information, etc.). The status tray 544 can also provide a “hamburger” that, when selected, launches a dropdown menu, etc. A footer tray 546 may include a messaging icon 548 and the view select control 530. However, the information displayed in the trays 544, 546 may be displayed in either tray. Further, other information may be provided in either tray.

In this regard, the dashboard 540 encompasses at least a portion of the screen and defines a “view”. Each view represents the utilization of the tiles of the dashboard across the panel to be displayed (including prioritized states). As an example, a first view may present the first panel 510 in a prioritized state, and the second panel 512 in a non-prioritized state. The first view may also display battery information, e.g., in a third panel, depending upon available space, etc. Likewise, a second view may present the first panel 510 in a non-prioritized state, whereas the second panel 512 is displayed in a prioritized state. As with the first view, depending upon available space in the dashboard, additional panels may also be provided, e.g., a battery panel.

The display maintains the current view (i.e., state of the panels (prioritized or non-prioritized depending on the panel)) until either the operator manually changes the view, or the processor decides to change the view. For instance, the processor may detect engagement of the load handling feature of the materials handling vehicle, and automatically bring a load-prioritized view (including a prioritized load panel) into priority. As another example, the processor may detect that the operator engaged the traction control to start moving forward. Here, since travel is engaged, the processor may automatically bring a vehicle-prioritized view (including a prioritized travel panel) into priority. As a further example, if the processor detects that the operator (or someone else) selects the load panel, then the processor may prioritize the load panel in the load-prioritized view. In yet another example, if the processor detects that the operator (or someone else) clicks on the view select control that toggles between a vehicle-prioritized view and a load-prioritized view, then the processor may toggle from the vehicle-prioritized view to the load-prioritized view, or vice-versa.

Also, regardless of whether a given panel is in a prioritized state or a non-prioritized state, the processor continues to interact with the panels to present live data associated with that panel via the elements of the panel. Moreover, there can be more panels available than what fit into a single view. Thus, there can be tools that allow the operator to customize the panels, e.g., by relocating panels within the view (e.g., based upon tiles as described more fully herein). An operator may also be able to utilize some of a given view for customization, e.g., by selecting which panels appear in a given view.

Because the notification system utilizes dashboards that include feature prioritized views, the actual content of the panels can vary and scale, e.g., based upon the task, operator, type of materials handling vehicle, combinations thereof, etc. For instances, a load-prioritized view (including a prioritized load panel) may only display fork height information on a basic stock picker materials handling vehicle, but the same notification system may display fork height and tilt angle information in the load panel of a reach truck materials handling vehicle.

In this regard, each panel can have one or more elements, e.g., graphical representations, text, etc. The notification system may dynamically determine whether each element is viewable, e.g., based on context. For instance, the processor may auto-detect certain materials handling features and enable or disable certain elements within a given panel. As another example, the processor may utilize a configuration file to assign which elements within a panel will be displayed.

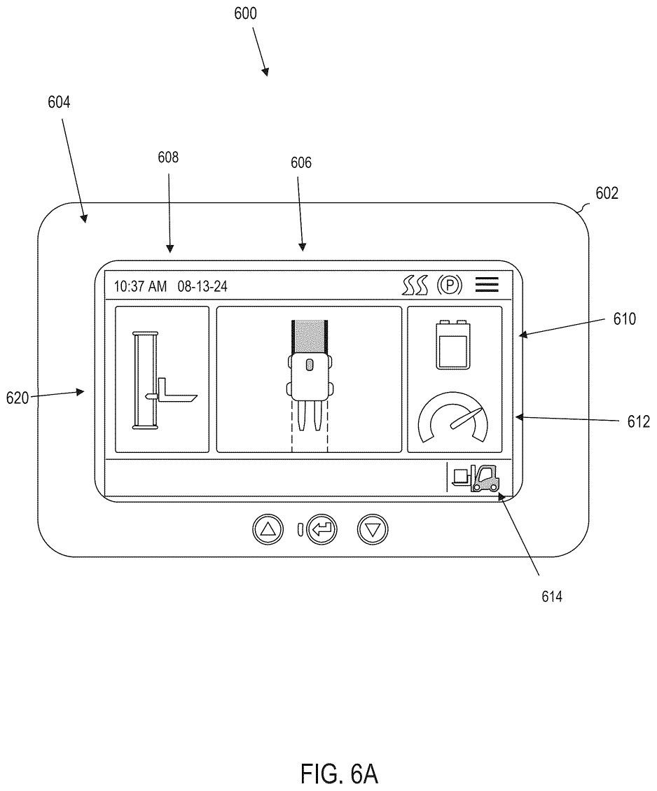

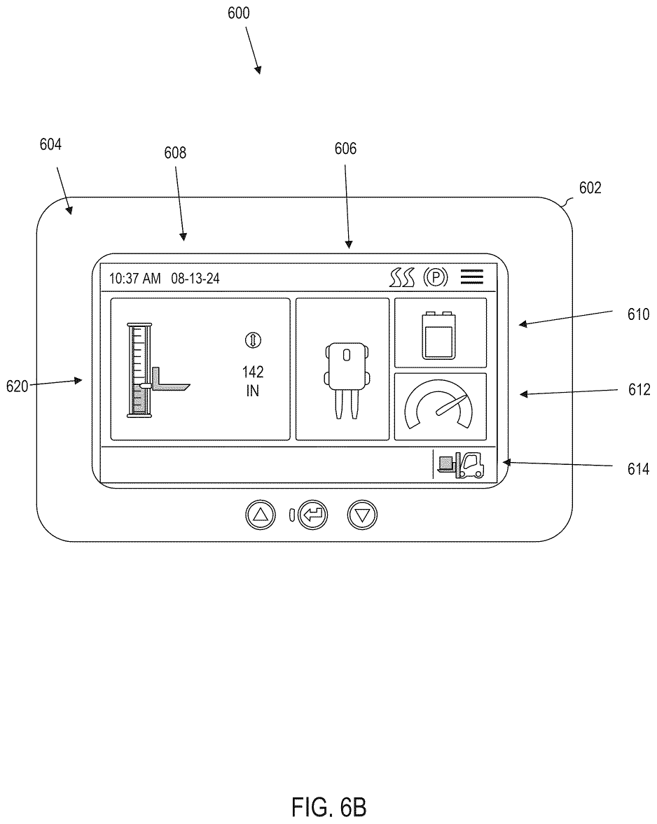

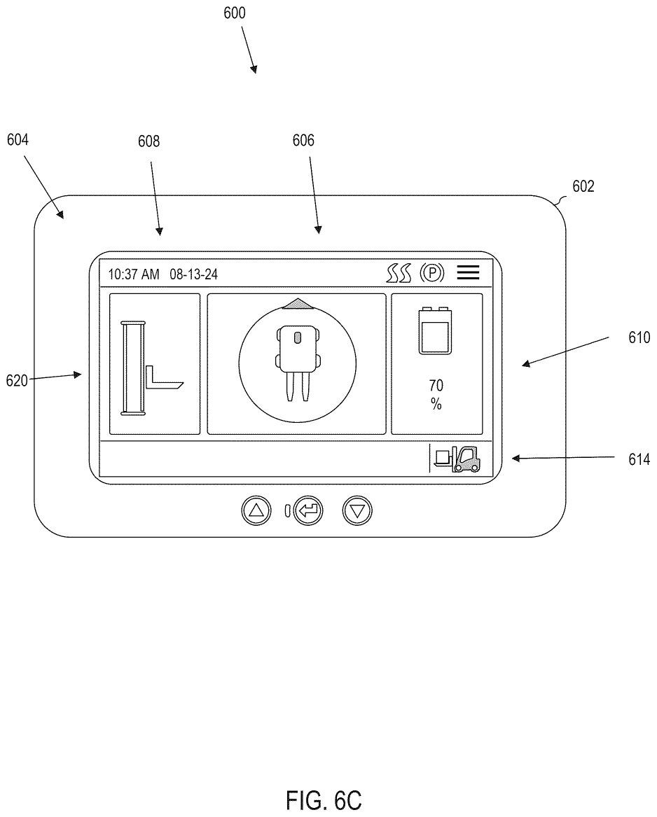

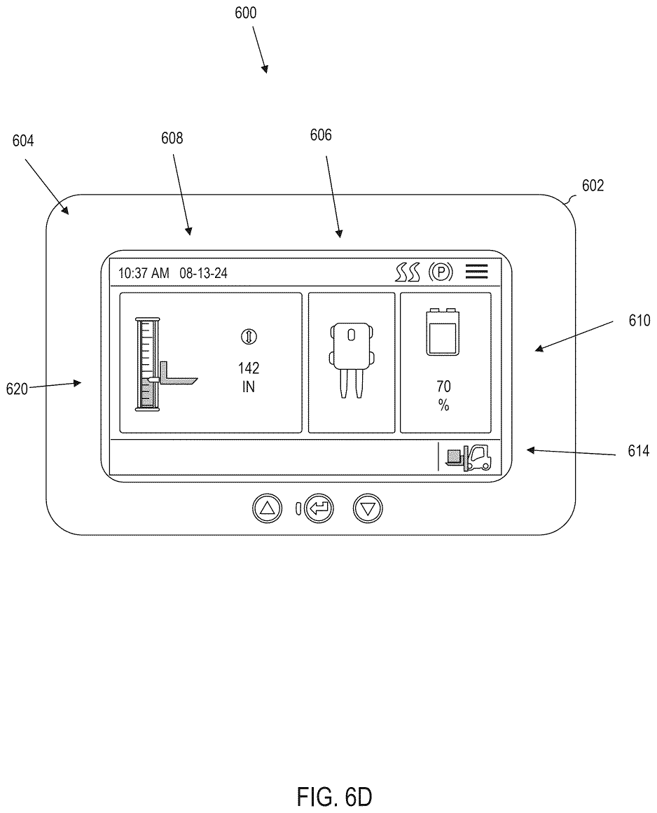

Example Panel Layouts and Prioritizations FIGS. 6A-D illustrate examples panels and prioritized states in two different panel layouts for an example notification system 600 for use in a materials handling vehicle. In FIG. 6A, the notification system 600 comprises a display 602, and as discussed above a processor may be within the display or separate from the display. A dashboard 620 of the panel layout 604 (i.e., the space between the trays of the panel layout, as discussed above in reference to FIGS. 5A-E) includes a first panel 606 implemented as a vehicle panel in a prioritized state, and includes an icon of a vehicle, a colored wheel orientation, and a colored travel path. The dashboard 620 further includes a second panel 608 implemented as a load panel in a non-prioritized state and includes an icon of a lift system with no colors but indicates a graphical height. Note that the prioritized vehicle panel 606 is twice as big as the non-prioritized load panel 608.

Moreover, the dashboard 620 includes two smaller customizable panels that an operator or user can determine what is displayed. In the dashboard 620 of FIG. 6A, the operator opted for a battery panel 610 and another panel 612. Note that the customizable panels 610 and 612 are not able to be prioritized or non-prioritized and show one informational element each. In the bottom right corner of the dashboard 620 is a view select control 614 that indicates that the layout is in a vehicle-based view (i.e., the vehicle panel 606 is prioritized), because the vehicle portion of the view-select control 614 is a color (gray in this case, but orange or another color may be used).

As discussed above, information read from the vehicle network bus, sensors, etc. will be reflected in the elements of the panels whether the panels are prioritized or not. For example, if the wheel changes orientation, then the wheel element icon will change direction and the travel path may change as well. As another example, if the forks change height, then the height change will be reflected in the non-prioritized load panel 608.

FIG. 6B illustrates the dashboard 620 of FIG. 6A where the view has transitioned to a load-based view. As discussed above, the transition can occur due to the operator selecting the view select control 614, the vehicle detecting that the vehicle has stopped and a hydraulic lift has engaged, or other things. In the load-based view, the vehicle panel 606 becomes non-prioritized (e.g., changes the colored-wheel orientation to a non-colored wheel, removes the travel path, and becomes smaller in dimensions) while the load icon 608 becomes prioritized (i.e., in the prioritized state), where the graphical height and load forks gain a color, and a new element of an actual height of the forks is listed in numerical form to the right of the height icon. In some embodiments, a prioritized load panel may also include a weight of a load on the forks. Further, regardless of how the view of the dashboard 620 transitioned, the view select control 614 indicates that the layout is in a load-based view (i.e., the load panel 606 is prioritized), because the load portion of the view-select control 614 is gray. Further, the custom panels 610 and 612 remain the same as they were in the vehicle-based view.

In FIG. 6C, the display 602 of the notification system 600 includes a second dashboard 620 that includes a first panel 606 implemented as a vehicle panel in a prioritized state, which includes an icon of a vehicle, a colored wheel orientation, and a steering wheel direction. The dashboard 620 further includes a second panel 608 implemented as a load panel in a non-prioritized state and includes an icon of a lift system with no colors but indicates a graphical height. Note that the prioritized vehicle panel 606 is twice as big as the non-prioritized load panel 608.

Moreover, the dashboard 620 includes a smaller customizable panel that an operator or user can determine what is displayed. In the dashboard second layout 604 of FIG. 6C, the operator opted for a battery panel 610. Note that the customizable panel is not able to be prioritized or non-prioritized. In the bottom right corner of the dashboard 620 is a view select control 614 that indicates that the layout is in a vehicle-based view (i.e., the vehicle panel 606 is prioritized), because the vehicle portion of the view-select control 614 is a color (gray in this case).

FIG. 6D illustrates the second dashboard 620 of FIG. 6C where the view has transitioned to a load-based view. As discussed above, the transition can occur due to the operator selecting the view select control 614, the vehicle detecting that the vehicle has stopped and a hydraulic lift has engaged, or other things. In the load-based view, the vehicle panel 606 becomes non-prioritized (e.g., changes the colored-wheel orientation to a non-colored wheel, removes steering wheel orientation element, and becomes smaller in dimensions) while the load icon 608 becomes prioritized (i.e., in the prioritized state), where the graphical height and load forks gain a color, and a new element of an actual height of the forks is listed in numerical form to the right of the height icon. In some embodiments, a prioritized load panel may also include a weight of a load on the forks. Further, regardless of how the view of the dashboard 620 transitioned, the view select control 614 indicates that the layout is in a load-based view (i.e., the load panel 606 is prioritized), because the load portion of the view-select control 614 is gray. Further, the custom panel 610 remains the same as it was in the vehicle-based view.

### Example Process of Implementing a Notification System

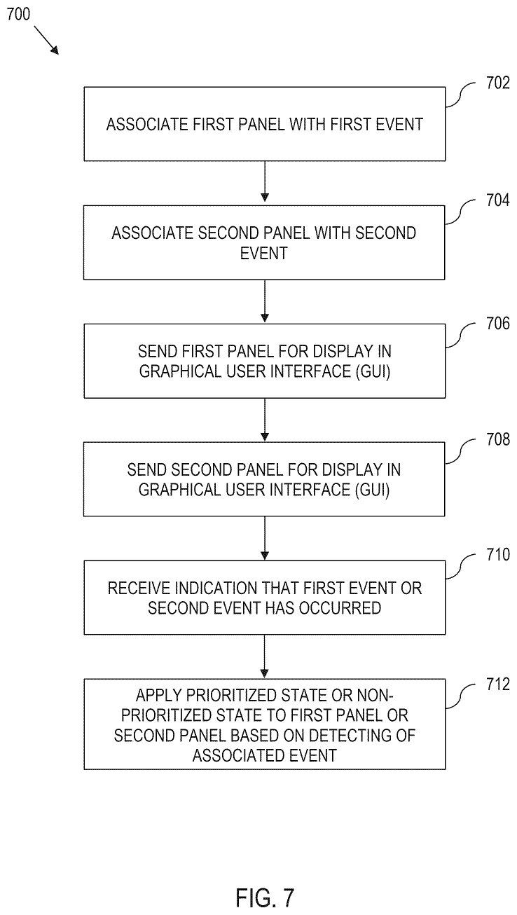

Referring to FIG. 7, a process 700 is provided, which can be useful for implementing a notification system. The process 700 can utilize any combination of features described with reference to the preceding features.

The process 700 comprises associating at 702, a first panel with a first event. Here, the first panel includes an indication of live materials handling vehicle data associated with a first vehicle function and can be controlled to toggle between a prioritized state and a non-prioritized state.

The process 700 also comprises associating at 704, a second panel with a second event. Here, the second panel includes an indication of live materials handling vehicle data associated with a second vehicle function and can be controlled to toggle between a prioritized state and a non-prioritized state.

The process 700 further comprises sending at 706, the first panel for display in a graphical user interface (GUI).

Likewise, the process 700 further comprises sending at 708, the second panel for display in the GUI.

The process 700 moreover comprises receiving at 710, an indication that the first event or the second event has occurred.

Also, the process 700 comprises applying at 712, the prioritized state or the non-prioritized state to the first panel or the second panel based on the detecting of the associated event.

In some implementations of the process 700, applying at 712, the prioritized state or the non-prioritized state to the first panel or the second panel based on the detecting of the associated event, can further include ensuring that only one of the first panel and the second panel is in the prioritized state at any given time.

In some implementations of the process 700, receiving at 710, an indication that the first event or the second event has occurred can include monitoring a vehicle communication bus of the materials handling vehicle for data associated with the event.

In some implementations of the process 700, receiving at 710, an indication that the first event or the second event has occurred, can include detecting a user selection of the first panel or second panel via the GUI.

In some implementations of the process 700, receiving at 710, an indication that the first event or the second event has occurred, can include determining a current task of the materials handling vehicle.

In some implementations of the process 700, the GUI can include a dashboard. Here, the first panel and the second panel are presented in the dashboard.

In some implementations of the process 700, the panel space can include tiles as a smallest unit of resolution for a panel. Under this configuration, the first panel may include more tiles when in the prioritized state than when in the non-prioritized state.

In some implementations of the process 700, the GUI can further include a status tray that is separate from the panel space.

In some implementations of the process 700, the first panel can include more displayed information when in the prioritized state than when in the non-prioritized state.

In some implementations of the process 700, the first panel can be displayed in a first color when in the prioritized state and a second color when in the non-prioritized state.

In some implementations of the process 700, the first panel can be larger when in the prioritized state than when in the non-prioritized state.

Different triggers can automatically switch views. For example, an event tree (i.e., a set of prioritized events that may be related serially or not) for a vehicle (e.g., a stock picker) capable of using wire guidance may be the following. First, if there is a change in a state of the wire guidance system (e.g., did the vehicle turn onto a wire-guided area, did the vehicle turn off a wire-guided area, is the vehicle searching for a wire, is the vehicle acquiring a wire, is there an error with the system, etc.) (i.e., a first event), then the vehicle-based view is activated. Further, if there is no change in the state of the wire-guidance system, then if the operator of the vehicle has stepped off a platform of the vehicle (i.e., a second event), then the vehicle-based view is activated.

If there is no change in the state of the wire-guidance system and the operator is on the platform, then if wire guidance is acquired (i.e., a third event), the height of forks of the vehicle is checked to determine if they are above a height threshold (e.g., twelve inches). If the height of the forks surpasses the height threshold (i.e., a fourth event), then the load-based view is activated, but if the height does not surpass the height threshold, then the view remains at the previous prioritization.

On the other hand, if there is no change in the state of the wire-guidance system and the operator is on the platform, then if wire guidance is not acquired, the speed of the vehicle is checked to determine if it surpasses a speed threshold (e.g., three miles per hour). If the speed of the vehicle surpasses the speed threshold (a fifth event), then the vehicle-based view is activated, but if the speed does not surpass the speed threshold, then the view remains at the previous prioritization.

Using the example above, the vehicle-based view is prioritized when the wire-guidance system has changed or when the operator is not detected on the platform. If neither of those conditions are true, then the load-based view is displayed if the height surpasses a height threshold and the vehicle has acquired a wire and the vehicle-based view is activated if the vehicle speed surpasses a speed threshold and the vehicle has not acquired a wire. Otherwise, the view remains the same.

As another example of automatically changing views, an event tree for a vehicle (e.g., a reach truck) that does not include a wire-guidance system may include the following. If the lift height is above a height threshold (e.g., two feet) (i.e., a first event), then the load-based view is displayed. If not, then the speed of the vehicle is evaluated, and if the speed of the vehicle is above a speed threshold (e.g., five miles per hour) (i.e., a second event), then the vehicle-based view is displayed.

If neither of those conditions happen, then if the vehicle senses that the operator got off the vehicle and then back on the vehicle (i.e., a third event), the vehicle-based view is displayed. However, if the vehicle senses that the operator did not get off the vehicle and then back on the vehicle, then a load on the forks is compared to a weight threshold (e.g., one-hundred pounds), and if the weight surpasses the weight threshold, then display the load-based view. Otherwise, the display remains on whichever view is currently being displayed.

The examples above are examples of trigger-trees that may be used to automatically switch views based on vehicle conditions. However, other triggers and trigger trees may be implemented.

In many embodiments, a view must be displayed for a minimum time period (e.g., two seconds) before switching to a different view. In various embodiments, if a user manually overrides which view is displayed (as described herein), then that view will remain displayed for at least the minimum period and until another trigger is activated.

Launching Applications from the Notification System

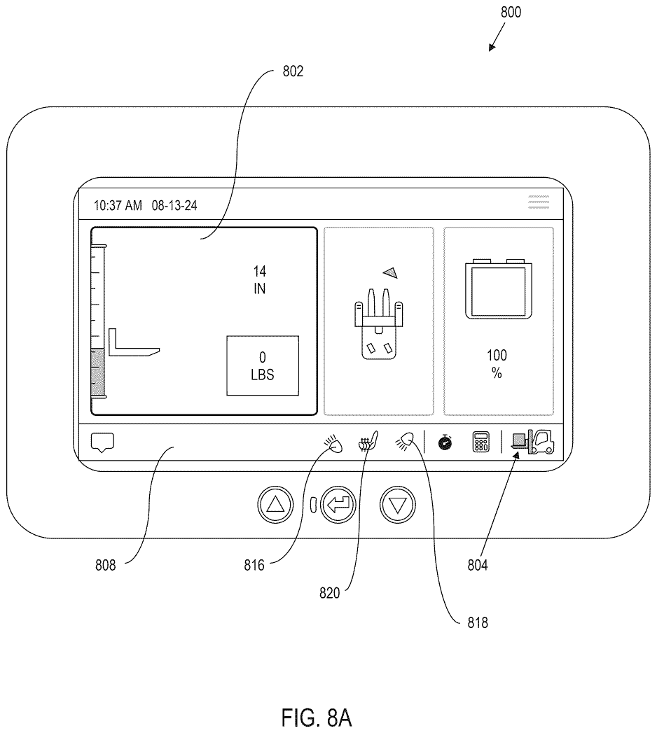

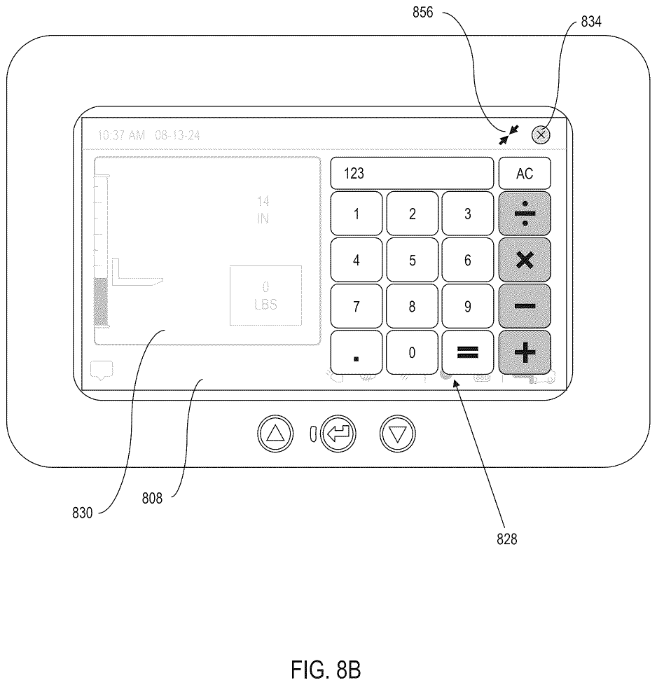

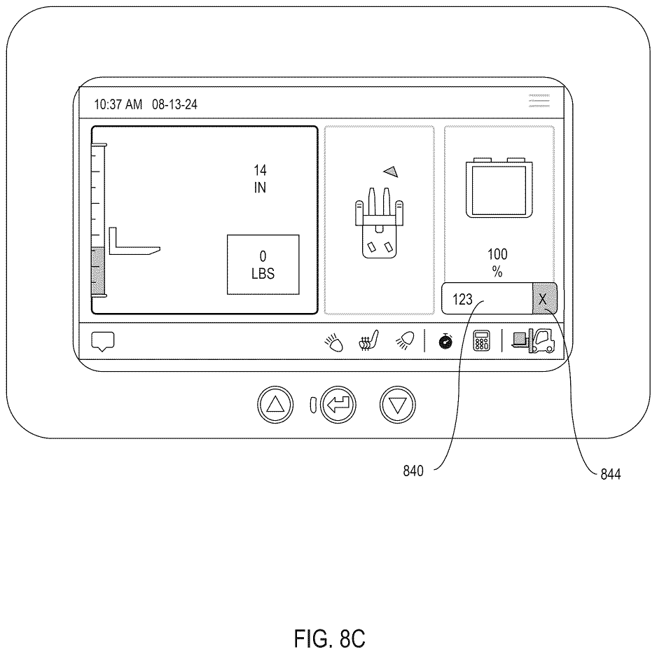

Referring to FIGS. 8A-C, starting with 8A, the notification system 800 is in a load-based view. A footer tray 808 includes an interactive message icon 810 and a view-select control 814, as discussed above. Further, the footer tray 808 includes lights icons 816, 818 and a seat control icon 820. These icons 816, 818, and 820 are interactive icons that allow a user to turn on/off features associated with the icon.

Moreover, the footer tray 808 includes application icons (e.g., a timer icon 822, calculator icon 824, etc.) that launch applications associated with the icons when a user interacts with the icon. For example, if a user interacts with the calculator icon 824, then a calculator application 828 will launch, as shown in FIG. 8B.

When an application is active, the application 828 becomes a focus of the display and the other portions (e.g., load panel 830, footer tray 808, etc.) are faded out to show the focus being the application 828. The calculator application 828 includes normal features of a calculator, along with a cancel icon 834 and a minimize icon 836. If the cancel icon 834 is selected, then the application 828 will close with no memory of what was entered. However, if the minimize icon 836 is selected, then the application 828 is closed except for an interactive window 840, as shown in FIG. 8C. When the application is minimized (or ended), the faded portions of the display are set back to normal. The calculation result in the window 840 may be used later on. Also, a cancel button 844 allows a user to cancel the interactive window 840 associated with the application.

### Miscellaneous

According to further aspects of the present disclosure, the notification system enables customization of industrial vehicle operational information, including customization of panels, messaging, themes, language and other features. Moreover, in an example implementation, a vehicle operator can interact with a display of the notification system, e.g., to set up, organize, customize, etc., panels and other display elements, or otherwise provide feedback to an associated processor using the controls of the display, the touch screen features of the display, or combinations thereof.

The disclosure herein improves the technologies of materials handling vehicles, operator-to-machine interaction, operation of a materials handling vehicle in a work environment, and effective information push to the operator and information retrieval by the operator. In particular, various aspects of the present disclosure address the technical problem of computer interaction in industrial environments by providing a notification system that graphically displays panels that dynamically change to provide glanceable information without the need for operator interaction. Moreover, messaging integrates with the panels to draw attention to the areas of the materials handling vehicle that are being addressed by the messaging. In other words, the panels are kept in the same area of the dashboard and are adjusted in size, color, amount of elements displayed, etc., but the panels still remain in the same place on the display as opposed to swapping new panels in, moving panels around on the display etc.

The present disclosure also addresses the technical problem of efficiently and effectively displaying (and optionally selectively obscuring and revealing) data including operational factors including time, industrial vehicle operating conditions and/or state, environmental conditions and/or state, operator conditions and/or state, combinations thereof, etc.

The processes set out herein are necessarily rooted in computer technology to overcome problems arising with graphical user interfaces in industrial applications. In this regard, the processing devices set out herein are not merely general-purpose computer components. Rather, the processing devices are special purpose machines built specifically for materials handling vehicles used in dynamic and mobile work environments that can require multiple modes of operator interaction and operation.

The technical solutions herein bring about several technical effects, including an ability to seamlessly and dynamically switch between prioritized information, as the job and the specific application dictates. The technical solutions also bring about improved industrial vehicle performance via efficient and effective display of relevant information, including vehicle operating conditions and/or state, environmental conditions and/or state, operator conditions and/or state, combination thereof, etc.

What is claimed is:

1. A notification system for use in a materials handling vehicle, the notification system comprising:
a display having a screen that displays a panel layout that includes:
a graphical user interface (GUI) including:
a first panel displaying live vehicle data associated with a first vehicle function, wherein the first panel can be controlled to toggle between a prioritized state and a non-prioritized state; and
a second panel displaying live vehicle data associated with a second vehicle function, wherein the second panel can be controlled to toggle between a prioritized state and a non-prioritized state; and
a processor communicably coupled to the display to control the GUI, wherein the processor is programmed to:
detect an event associated with the first panel or the second panel; and
apply the prioritized state or the non-prioritized state to the first panel or the second panel based on the detecting of the associated event.

2. The notification system of claim 1, wherein the processor is further programmed to ensure that only one of the first panel or the second panel is in the prioritized state at any given time.

3. The notification system of claim 1, wherein the processor being programmed to detect an event comprises being programmed to monitor an interface of the materials handling vehicle for data associated with the event.

4. The notification system of claim 1, wherein the processor being programmed to detect an event comprises being programmed to detect a user selection of the first panel or second panel.

5. The notification system of claim 1, wherein the processor being programmed to detect an event comprises determining a current task of the materials handling vehicle.

6. The notification system of claim 1, wherein the first panel includes more displayed information when in the prioritized state than when in the non-prioritized state.

7. The notification system of claim 1, wherein the first panel is larger when in the prioritized state than when in the non-prioritized state.

8. The notification system of claim 1, wherein:
the panel view includes a dashboard; and
the first panel and the second panel are in the dashboard.

9. The notification system of claim 8, wherein:
the dashboard includes tiles as a smallest unit of resolution for a panel; and
the first panel includes more tiles when in the prioritized state than when in the non-prioritized state.

10. The notification system of claim 8, wherein the GUI further includes a status tray that is separate from the dashboard.

11. A process comprising:
associating a first panel with a first event, wherein the first panel:
includes an indication of live materials handling vehicle data associated with a first vehicle function; and
can be controlled to toggle between a prioritized state and a non-prioritized state;
associating a second panel with a second event, wherein the second panel:
includes an indication of live materials handling vehicle data associated with a second vehicle function; and
can be controlled to toggle between a prioritized state and a non-prioritized state;
sending the first panel for display in a graphical user interface (GUI);
sending the second panel for display in the GUI;
receiving an indication that the first event or the second event has occurred; and
applying the prioritized state or the non-prioritized state to the first panel or the second panel based on the detecting of the associated event.

12. The process of claim 11, wherein applying the prioritized state or the non-prioritized state to the first panel or the second panel based on the detecting of the associated event further includes ensuring that only one of the first panel or the second panel is in the prioritized state at any given time.

13. The process of claim 11, wherein receiving an indication that the first event or the second event has occurred includes monitoring a vehicle communication bus of the materials handling vehicle for data associated with the event.

14. The process of claim 11, wherein receiving an indication that the first event or the second event has occurred includes detecting a user selection of the first panel or second panel via the GUI.

15. The process of claim 11, wherein receiving an indication that the first event or the second event has occurred includes determining a current task of the materials handling vehicle.

16. The process of claim 11, wherein:
the GUI includes a dashboard; and
the first panel and the second panel are in the dashboard.

17. The process of claim 16, wherein the dashboard includes tiles as a smallest unit of resolution for a panel.

18. The process of claim 17, wherein the first panel includes more tiles when in the prioritized state than when in the non-prioritized state.

19. The process of claim 11, wherein the first panel includes more displayed information when in the prioritized state than when in the non-prioritized state.

20. The process of claim 11, wherein the first panel is larger when in the prioritized state than when in the non-prioritized state.
